(19) United States
(12) Patent Application Publication
(10) Pub. No.: US 2016/0137116 A1
(43) Pub. Date: May 19, 2016

(54) METHOD FOR CONTROLLING AUTO DUMP OPERATION OF HAULING MACHINES

(71) Applicant: Caterpillar Inc., Peoria, IL (US)

(72) Inventors: Badri N. Chary, Chennai (IN); Mark R. Blackburn, Chennai (IN)

(73) Assignee: Caterpillar Inc., Peoria, IL (US)

(21) Appl. No.: 15/005,024

(22) Filed: Jan. 25, 2016

(51) Int. Cl. B60P 1/16

(52) U.S. Cl. CPC B60P 1/162

(57) ABSTRACT

A method to control a dump body of a hauling machine having a hoist cylinder, a lift energy source, a first sensor, and a second sensor, is provided. The method includes prompt of enablement of an auto dump operation and detection a dump body angle by correlating one or more signals obtained from the first sensor and the second sensor. Upon determination that the dump body angle is zero degrees, hydraulic pressure is provided to the hoist cylinder to tilt the dump body. An angular displacement rate of the hoist cylinder is detected by determination of a change in the dump body angle, with respect to time. The hydraulic pressure to the hoist cylinder is controlled based on the angular displacement rate. The hydraulic pressure is controlled to halt the tilting of the hoist cylinder upon detection that the dump body angle is equal to a pre-determined dump body angle.

### TECHNICAL FIELD

The present disclosure relates generally to hauling machines. More specifically, the present disclosure relates to method for controlling auto dump operation of a hauling machine.

### BACKGROUND

Machines such as, on and off-highway haul trucks, and other types of heavy equipment are used to perform a variety of tasks. Some of these tasks may involve carrying large, loose, and/or heavy loads. The machines are often used as a way to transport material from a loading location to a dumping location. Such machines include a dump body configured to contain or hold the material. The dump body is raised to dump the material at the dumping location. However, prior to raising the dump body, an operator needs to ensure the proper machine speed and the orientation of the machine. Further, during dumping operation, the operator may control a hoist mechanism to raise the dump body. Also, the operator may need to manually ensure that the dump body is inclined at an optimum dump body angle to dump the material completely. As a result, over the period of a work shift, multiple manual dump operations contribute to fatigue experienced by the operator. A number of manual operations increase dump operation time, and thus affects productivity. Moreover, the above-mentioned operations being performed manually may lead to misuse of engine, transmission, and brakes by the operator. Hence, due to inconsistencies in manual dumping operations, hauling production may be generally adversely affected.

United States Patent 2014/222303 discloses an automatic method to control hoisting of a dump body based on payload detected by a payload ECM.

The present disclosure is directed towards solving one or more above-mentioned problems.

### SUMMARY OF THE DISCLOSURE

Various aspects of the present disclosure relates to a method to control a dump body of a hauling machine. The hauling machine includes an engine, at least one hoist cylinder, a lift energy source, at least one controller, a first sensor, and a second sensor. The lift energy source is connected to the at least one hoist cylinder. The at least one hoist cylinder is attached to the dump body and is configured to incline the dump body for evacuation of a payload. The first sensor determines angle of the hauling machine relative to the horizontal. The second sensor determines angle of the dump body relative to the horizontal. The method includes prompting of enablement of an auto dump operation. A dump body angle of the dump body is detected by correlating data obtained from the first sensor and the second sensor. Hydraulic pressure is provided to the at least one hoist cylinder to tilt the at least one hoist cylinder upon determination that the dump body angle is approximately 0°. The angular displacement rate of the hoist cylinder is detected by determination of a change in the dump body angle, with respect to time. The hydraulic pressure to the hoist cylinder is controlled based on the angular displacement rate. The dump body angle of the dump body is determined by correlating data obtained from the first sensor and the second sensor. The hydraulic pressure is controlled to halt the tilting of the hoist cylinder upon detection that the dump body angle is equal to a pre-determined dump body angle.

### BRIEF DESCRIPTION OF THE DRAWINGS

FIG. 1 is a side view of a hauling machine with a dump body in a rest position, in accordance with the concepts of the present disclosure;

FIG. 2 is a side view of the hauling machine shown in FIG. 1, with the dump body shown in a dumping operation, in accordance with the concepts of the present disclosure;

FIG. 3 is a block diagram illustrating a layout of an auto dump control system for the hauling machine of FIG. 1; and

FIG. 4 is a flowchart illustrating a method for the auto dump control system of the hauling machine of FIG. 1 and in accordance with the concepts of the present disclosure.

### DETAILED DESCRIPTION

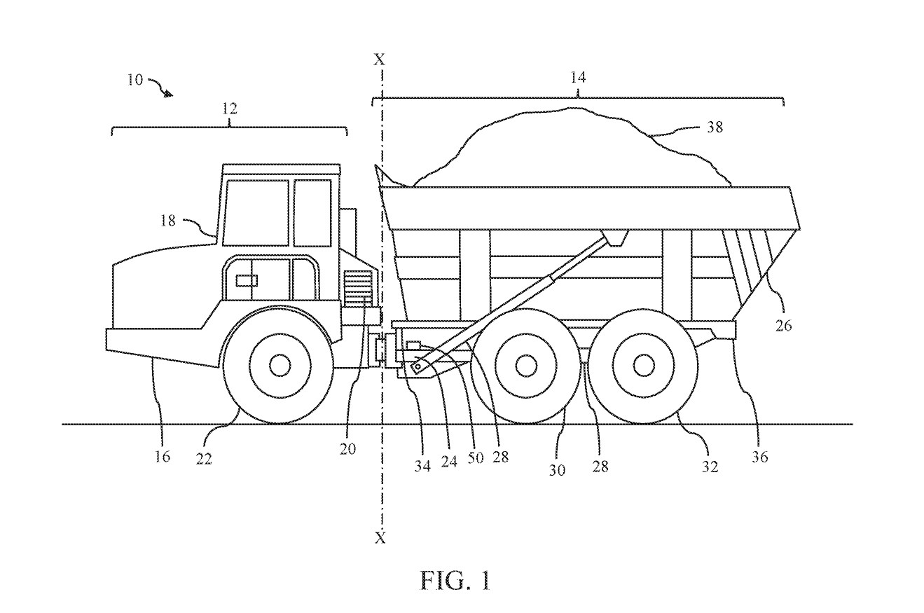

Referring to FIG. 1, there is shown a hauling machine 10 which includes a front unit 12 and a rear unit 14. The front unit 12 and the rear unit 14 may be pivotably coupled to pivot about an axis X-X. The front unit 12 includes a front frame 16, an operator cab 18, and an engine 20. The front frame 16 is mounted on a first pair of front wheel assembly 22 associated with the front unit 12. The front frame 16 of the front unit 12 supports the operator cab 18 and the engine 20. The operator cab 18 may include devices that receive input from a machine operator to indicate a desired maneuvering of the hauling machine 10. The operator cab 18 may include one or more operator interface devices. Examples of operator interface devices include, but are not limited to, a joystick, a steering wheel, and/or a pedal (none of which are shown but are commonly known in the industry). In an embodiment, the hauling machine 10 may be a large mining truck or any other equipment that is used for similar applications.

The rear unit 14 includes a rear frame 24, a dump body 26, and a pair of hoist cylinders 28. The hauling machine 10 may include a single hydraulic cylinder, for example, a pair of hoist cylinders as is customary, or a plurality of cylinders to raise the dump body 26. The rear frame 24 is mounted on a first pair of rear wheel assembly 30 and a second pair of rear wheel assembly 32, associated with the rear unit 14. The rear frame 24 supports the pivotable dump body 26 and the pair of hoist cylinders 28.

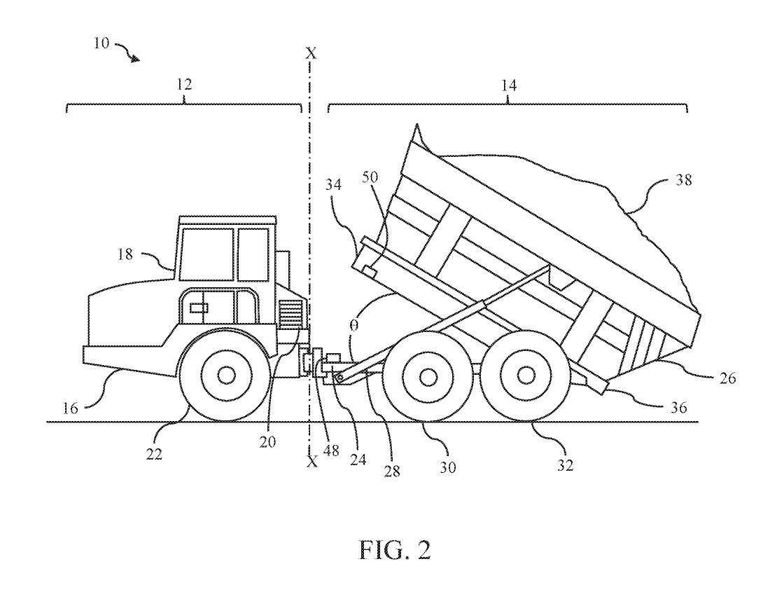

The dump body 26 includes a first end 34 and a second end 36. In an embodiment, the first end 34 of the dump body 26 is the portion which will be raised while dumping a payload 38. The second end 36 is the portion where the tipping of the dump body 26 occurs (FIG. 2). The dump body 26 is configured to carry the payload 38 and is coupled to the pair of hoist cylinders 28. The pair of hoist cylinders 28 is coupled to the dump body 26. The pair of hoist cylinders 28 are actuated to tip the dump body 26 at a dump body angle relative to the rear frame 24 (FIG. 2). The pair of hoist cylinders 28 may be hydraulic cylinders or hydro-pneumatic cylinders.

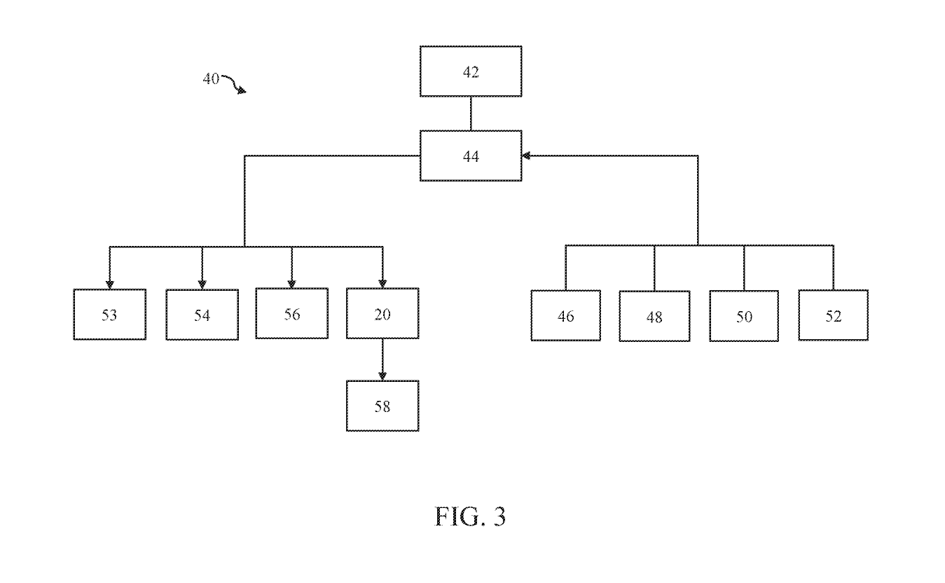

Referring to FIG. 3, an auto dump control system 40 for the hauling machine 10 will now be described in detail. The auto dump control system 40 includes a graphical display 42, a controller 44, a machine speed sensor 46, a first sensor 48, a second sensor 50, transmission 52, service brakes 54, and park brakes 56.

The graphical display 42 may include a plurality of input buttons (not shown) to operate the auto dump control system 40. At least one input key of the plurality of input buttons (not shown) on the graphical display 42 may be used to enable and/or disable an auto dump operation. After enabling the auto dump operation and entering a pre-determined dump body angle by the plurality of input buttons (not shown) on the graphical display 42, the initiation of the auto dump operation is prompted by the operator with the help of a hoist lever (not shown) or any other initiating device or means known in the art. The graphical display 42 is electrically communicated to the controller 44 through data links for the purpose of transmitting and receiving information. Examples of the data links may include, but are not limited to a controller area network bus automotive network (CANBUS) and/or (CAT) data link. The graphical display 42 may also display a video from a rear view camera (not shown).

The controller 44 receives outputs of various sensing sources such as the machine speed sensor 46, the first sensor 48, and the second sensor 50. Based on inputs received from the above-mentioned sensors, the controller 44 generates outputs to control the transmission 52, service brake 54, and park brake 56. Further, the controller 44 generates outputs to the engine 20 which in turn controls a lift energy source 58.

The lift energy source 58 is connected to the pair of hoist cylinders 28 and is adapted to actuate the pair of hoist cylinders 28. In an embodiment, the lift energy source 58 can be a hydraulic pump, a pneumatic pump, or a motor. The controller 44 calculates a ramp rate required for the lift energy source 58 to lift the dump body 26 carrying the payload 38. On calculation of the ramp rate for the lift energy source 58, the controller 44 calculates an engine throttle for the engine 20 based on the configured ramp rate. The engine 20 is controlled by the controller 44 to operate at the calculated engine throttle in order to provide the configured ramp rate to the lift energy source 58. The lift energy source 58 operates at the configured ramp rate to provide fluid to the pair of hoist cylinders 28 to extend the pair of hoist cylinders 28. Pressure of the fluid in the pair of hoist cylinders 28 results in expansion and retraction of the pair of hoist cylinders 28. The expansion and retraction of the pair of hoist cylinders 28 raises and lowers the dump body 26, respectively.

The first sensor 48 is mounted to the rear frame 24. The first sensor 48 is adapted to determine an angle of the hauling machine 10 (or the rear frame 24) relative to the horizontal. The second sensor 50 is similar in form and function to the first sensor 48. The second sensor 50 is mounted on the dump body 26, at the first end 34 (also see FIG. 2). The second sensor 50 is adapted to determine an angle of the dump body 26 relative to the horizontal. A hoist body angle (θ) is determined by the controller 44, by deriving and correlating data from the first sensor 48 and the second sensor 50. The hoist body angle (θ) is the angle of displacement between the rear frame 24 and dump body 26.

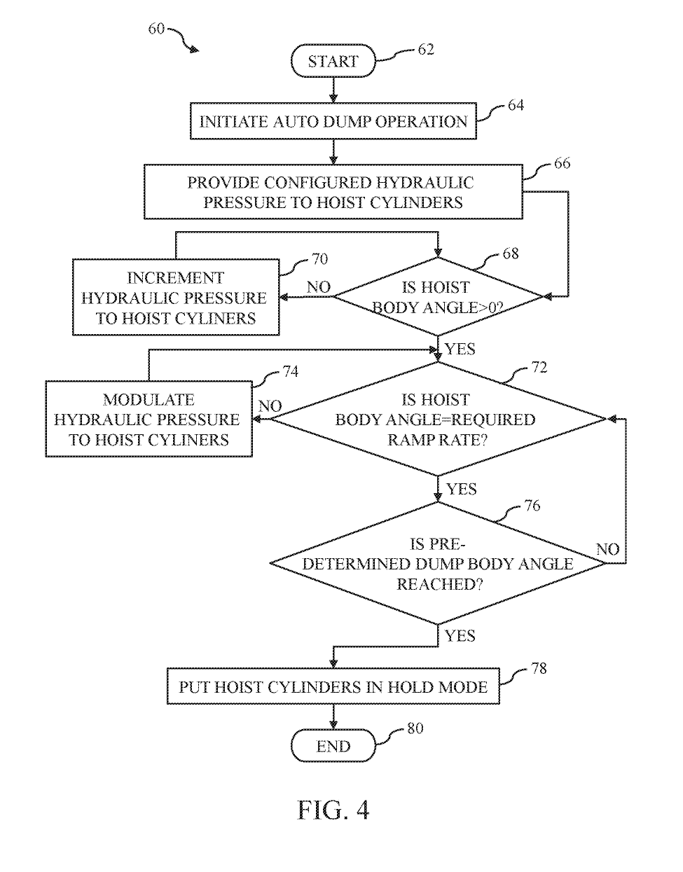

Referring now to FIG. 4, a method 60 for dump control for the hauling machine 10, in accordance with the concepts of the present disclosure will now be described. The method 60 starts at step 62. The method 60 proceeds to step 64.

At 64, the auto dump operation is enabled the at least one input key of the plurality of input buttons (not shown) on the graphical display 42. The auto dump operation is initiated by the hoist lever (not shown) or any other actuating means known in the art. The method 60 proceeds to step 66.

At step 66, the controller 44 sends the engine throttle signal to the engine 20, based on the pre-determined dump body angle. The engine 20 operates for the calculated engine throttle corresponding to the engine throttle signal. Accordingly, the engine throttle provides the configured ramp rate to the lift energy source 58 to lift the dump body 26. The lift energy source 58 operates at the configured ramp rate to provide the configured hydraulic pressure to the pair of hoist cylinders 28 to extend the pair of hoist cylinders 28. The method 60 proceeds to step 68.

At step 68, the controller 44 determines the hoist body angle (θ) based on signals received from the first sensor 48 and the second sensor 50. The controller 44 prompts if the hoist body angle (θ) is greater than zero. If the hoist body angle (θ) is zero or lesser than zero, then the method 60 goes to step 70. If the hoist body angle (θ) is greater than zero, then the method 60 proceeds to step 72.

At step 70, the controller 44 sends the engine throttle signal to increment the engine throttle to the engine 20. The engine 20 operates for the increased engine throttle corresponding to the increment. Accordingly, the increased engine throttle provides an accelerated ramp rate to the lift energy source 58 to lift the dump body 26. The lift energy source 58 operates at the accelerated ramp rate to provide more fluid to the pair of hoist cylinders 28 to further extend the pair of hoist cylinders 28. The method 60 goes to step 68.

At step 72, the controller 44 prompts whether the hoist body angle (θ) is equal to a configured ramp rate. Subsequently, the controller 44 also determines an angular displacement rate based on a change in the dump body angle with respect to time. If the hoist body angle (θ) is not equal to the configured ramp rate, then the method 60 proceeds to step 74. If the hoist body angle (θ) lies beyond the configured ramp rate, then the method 60 proceeds to step 76.

At step 74, the controller 44 sends the signal to the engine 20 to modulate the hydraulic pressure to the lift energy source 58 for the configured ramp rate. This implies that the configured hydraulic pressure corresponding to the configured ramp rate is based on the angular displacement rate. On acceleration of the lift energy source 58, the pair of hoist cylinders 28 expands further and the dump body 26 is lifted to dump the payload 38. The method 60 proceeds to step 72. The controller 44 determines if the dump body 26 is lesser or greater than the configured ramp rate. If the hoist body angle (θ) is greater than the configured ramp rate, the controller 44 sends the signal to the engine 20 to decelerate the lift energy source 58. If the hoist body angle (θ) is lesser than the configured ramp rate, the controller 44 sends the signal to the engine 20 to accelerate the lift energy source 58, based on the angular displacement rate. The method 60 goes to step 72.

At step 76, the controller 44 prompts whether the dump body angle is equal to the pre-determined dump body angle. If the dump body angle is equal to the pre-determined dump body angle, the method 60 proceeds to step 78. If the dump body angle is not equal to the pre-determined dump body angle, the method 60 goes to step 72.

At step 78, the controller 44 sends signals to the engine 20 to control the hydraulic pressure to the lift energy source 58. The hydraulic pressure is controlled to halt the tilting of the pair of hoist cylinders 28 upon detection that the dump body angle is equal to a pre-determined dump body angle. Accordingly, the pair of hoist cylinders 28 is maintained in a hold mode. In the hold mode, the dump body 26 is maintained at the pre-determined dump body angle. The method 60 halts at end step 80.

At end step 80, the controller 44 signals the engine 20 to stop the auto dump operation.

### INDUSTRIAL APPLICABILITY

In operation, the auto dump control system 40 allows the operator to enable the auto dump operation. Prior to initiation of the auto dump operation, the controller 44 receives a machine speed signal from the machine speed sensor 46. The controller 44 extracts the information of the machine speed from the machine speed signal and assesses if the machine speed is suitable for the dump operation. Upon determination of optimum machine speed, the controller 44 sends signals for shift of the transmission 52 to neutral. Further, the controller 44 may send signals to apply the service brake 54 and the park brake 56. Thereafter, the controller 44 communicates with the first sensor 48 and the second sensor 50. The first sensor 48 determines an angle of the rear frame 24 (or the hauling machine 10) relative to the horizontal, which is commonly referred to as a rear frame angle. The second sensor 50 determines an angle of the dump body 26 relative to the horizontal, which is commonly referred to as a dump body angle. The first sensor 48 and the second sensor 50 respectively generate a first position signal and a second position signal. The controller 44 receives the first position signal and the second position signal, and determines the hoist body angle (θ), by correlating data from the first position signal and the second position signal. The hoist body angle (θ) is the difference between the dump body angle and the rear frame angle.

The controller 44 energizes the lift energy source 58 for the configured ramp rate to lift the dump body 26. Based on the configured ramp rate, the controller 44 calculates the engine throttle for the engine 20 to energize the lift energy source 58 to lift the dump body 26. Subsequently, the controller 44 sends a signal to energize the lift energy source 58 to provide fluid in the pair of hoist cylinders 28 for building suitable fluid pressure. The controller 44 determines the angular displacement rate based on the change in the dump body angle with respect to time. The hydraulic pressure thus provided further to the lift energy source 58 corresponds to the angular displacement rate. This is done, till the dump body 26 attains the pre-determined dump body angle for the dumping operation. Hence, controlling the engine 20 to operate at the calculated engine throttle aids in the achievement of fuel economy by limiting the engine throttle to a calculated value based on the payload 38.

As compared to existing dump control systems, the disclosed auto dump control system 40 prevents machine abuse by the operator, as upon the determination of initiation of the auto dump operation by the controller 44, there is reduced need for interference by the operator to achieve functionality of the auto dump control system 40. This is a contributing factor towards operator safety. Also, it reduces operator fatigue to a considerable extent, as it reduces the number of operations to be performed by the operator during the dump operation.

Further, for dumping operations primarily aimed at spreading the material, it is desired that the material is being dumped when the hauling machine 10 is moving at a desired speed and the dump body 26 is inclined at the desired dump body angle. The proposed auto dump control system 40 enables the operator to initiate the auto dump operation for such spreading operations.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A method of controlling a dump body of a hauling machine having an engine, at least one hoist cylinder, a lift energy source, at least one controller, a first sensor, and a second sensor, the lift energy source connected to the at least one hoist cylinder which is attached to the dump body and is configured to incline the dump body for evacuation of a payload therein, the first sensor to deduce angle of machine relative to the horizontal, and the second sensor to deduce angle of the dump body relative to the horizontal, the method comprising:
prompting enablement of an auto dump operation;
detecting a dump body angle of the dump body by correlating one or more signals obtained from the first sensor and the second sensor;
providing hydraulic pressure to the at least one hoist cylinder for tilting the at least one hoist cylinder upon determination that the dump body angle is approximately zero degrees and initiating angular movement of the dump body;
detecting an angular displacement rate of the at least one hoist cylinder by determining a change in the dump body angle, with respect to time;
controlling the hydraulic pressure to the at least one hoist cylinder based on the angular displacement rate;
detecting the dump body angle of the dump body by correlating data obtained from the first sensor and the second sensor; and
controlling the hydraulic pressure to halt the tilting of the at least one hoist cylinder upon detection that the dump body angle is equal to a pre-determined dump body angle.
